(19) United States
(12) Patent Application Publication
(10) Pub. No.: US 2007/0063044 A1
(43) Pub. Date: Mar. 22, 2007

(54) Paper sheet processing apparatus

(75) Inventors: Mitsuo Ryu, Ayase-shi (JP); Kunio Fukatsu, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/515,028

(22) Filed: Sep. 5, 2006

(30) Foreign Application Priority Data
Sep. 16, 2005 (JP) 2005-270965

(51) Int. Cl. G06K 7/10

(52) U.S. Cl. 235/462.01

(57) ABSTRACT

A mail processing apparatus has a conveying path to convey mail, a reader to read information about mail conveyed through the conveying path, and a processor to make unnecessary information unreadable when the information read by the reader includes unnecessary information.

### CROSS-REFERENCE TO RELATED APPLICATIONS

This application is based upon and claims the benefit of priority from prior Japanese Patent Application No. 2005-270965, filed Sep. 16, 2005, the entire contents of which are incorporated herein by reference.

### BACKGROUND OF THE INVENTION

1. Field of the Invention

The present invention relates to a paper sheet processing apparatus, which reads unnecessary information written on a paper sheet such as mail, and makes the unnecessary information unreadable in a later process.

2. Description of the Related Art

In a mail processing apparatus, address information 11 written on mail P as shown in FIG. 10 is read and recognized by a reading unit (not shown) such as OCR, and the recognized address information is converted into and printed as a first barcode information 12.

If the address information 11 is not recognized by the OCR, the address information is recognized by a video coding unit (not shown), and the recognized information is manually converted into and printed as a first barcode information 12. In this case, a second barcode information 13 indicating the failure of recognition is printed on the mail P, and finally two kinds of barcode information 12 and 13 are printed on the mail P.

Such mail printed with barcode information is sent to a delivery office. In the delivery office, such mail printed with barcode information is preferentially read and recognized by a barcode reader (not shown) of a sorting machine, and sorted for each by delivery area based on the read barcode information. The sorted mail is delivered to each address in each delivery area.

Incidentally, barcode information may not be correctly printed on mail. In such a case, mail cannot be delivered to its address, and returned to a delivery office as addressee unknown. The address information about returned mail is read by a sorting machine, and sorted and delivered again.

If an addressee has moved, the mail to that addressee is returned to a delivery office as addressee unknown. If a new address has been noticed to a delivery office, the mail is given the new address information and read by a sorting machine, and sorted and delivered again (refer to Jpn. Pat. Appln. KOKAI Publication No. 2002-346482).

However, conventionally, mail returned as addressee unknown is processed again by a sorting machine in the same state that the barcode information is left printed. This arises a problem that the same barcode information is read again, and the mail is delivered to a different address.

### BRIEF SUMMARY OF THE INVENTION

The present invention has been made under the above circumstances. Accordingly, it is an object of the invention to provide a paper sheet processing apparatus, which performs an unread processing for information unnecessary and undesirable if mechanically processed later, such as, a barcode, character and symbol on a paper sheet, and makes them unreadable.

According to a first aspect of the invention, there is provided a paper sheet processing apparatus comprising a conveying device which conveys a paper sheet, a reading device which reads information about a paper sheet conveyed by the conveying device, and a processing device which makes unnecessary information unreadable, when the information read by the reading device includes unnecessary information.

According to a second aspect of the invention, there is provided a paper sheet processing apparatus comprising a conveying device which conveys a paper sheet, a reading device which reads information about the paper sheet conveyed by the conveying device, and an ink transfer device which makes unnecessary information unreadable by transferring ink to unnecessary information, when the information read by the reading device includes unnecessary information.

According to a third aspect of the invention, there is provided a paper sheet processing apparatus comprising a conveying device which conveys a paper sheet, a reading device which reads information about the paper sheet conveyed by the conveying device, and an ink spray device which makes unnecessary information unreadable by overwriting unnecessary information by spraying ink in substantially the same form and slightly displaced from the unnecessary information, when the information read by the reading device includes unnecessary information.

According to a fourth aspect of the invention, there is provided a paper sheet processing apparatus comprising a conveying device which conveys a paper sheet, a reading device which reads information about the paper sheet conveyed by the conveying device, and an ink spray device which makes unnecessary information unreadable by spraying ink to unnecessary information, when the information read by the reading device includes unnecessary information.

In the apparatus according to the invention, unnecessary information written on a paper sheet is made unreadable, and unnecessary information is not read in a later process, thereby preventing a mis-processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram showing a mail processing apparatus according to an embodiment of the invention;

FIG. 2 is a perspective view showing a hub-type unread processor provided in the mail processing apparatus of FIG. 1;

FIG. 3 is a perspective view of the hub of the unread processor of FIG. 2;

FIG. 4 is a view showing mail processed to be unreadable by the unread processor of FIG. 2;

FIG. 5 is a perspective view of an inkjet printer type unread processor according to a second embodiment of the invention;

FIG. 6 is a view showing mail processed to be unreadable by the unread processor of FIG. 5;

FIG. 7 is a block diagram showing a bubble jet type unread processor according to a third embodiment of the invention;

FIG. 8 is a timing chart showing the operation of the unread processor of FIG. 7;

FIG. 9 is a view showing mail processed to be unreadable by the unread processor of FIG. 7; and

FIG. 10 is a view showing mail printed with barcodes.

### DETAILED DESCRIPTION OF THE INVENTION

Hereinafter preferred embodiments of the present invention will be explained in detail with reference to the accompanying drawings.

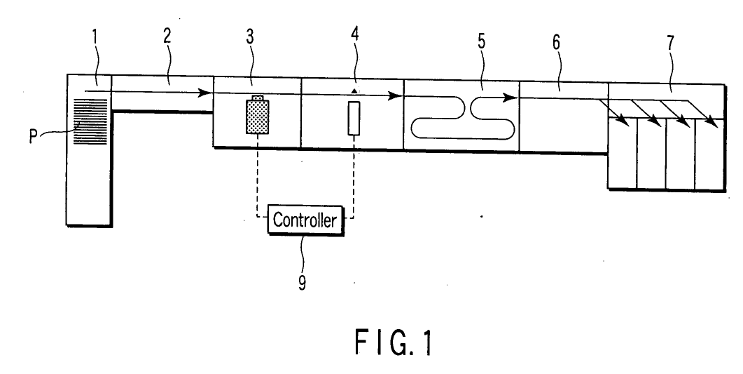

FIG. 1 is a schematic diagram showing a mail processing apparatus according to an embodiment of the invention.

In FIG. 1, a part denoted by 1 is a take-out unit, which holds mail P as a lot of paper sheet in a stacked state, and takes out one by one. The mail P taken from the take-out unit 1 is conveyed along a conveying path 2 as a conveying device. In the conveying path 2, a reader 3 as a reading device, an unread processor 4 as a processing device, a drier 5, a verify reader 6, and a stack unit 7 are provided along the mail conveying direction. The reader 3 and unread processor 4 are connected through a controller 9.

The reader 3 reads information unnecessary and undesirable if mechanically processed later, such as, a barcode, character and symbol on the mail P. The unread processor 4 makes unnecessary information read by the reader 3 unreadable, so that it is not processed later. The controller 9 operates the unread processor 4, based on that unnecessary information about the mail is read by the reader 3. The drier 5 dries mail after being processed unreadable. The verify reader 6 verifies that unnecessary information on mail has been made unreadable. The stack unit 7 sorts and stacks mail according to address information.

Explanation will be given on the processing operation of the mail processing apparatus configured as described above.

Mail P set in the take-out unit 1 is taken out and conveyed one by one to the reader 3, which reads the information about the mail P. If the information read by the reader 3 includes unnecessary information, such as, a barcode, character and symbol undesirable if mechanically processed later, the controller 9 operates the unread processor 4 to make the mail P unreadable, as described in detail later. After the unread processing, the mail P is sent to the dryer 5 for drying, and then sent to the verify reader 6 for verifying that the unnecessary information on the mail is unreadable. If the verify reader should not read the information subjected to the unread processing, the mail will be stacked in the stack unit 7.

Contrarily, if the verify reader 6 reads the unnecessary information on the mail after the unread processing by the unread processor 4, the unread processing is unsuccessful. In this case, the mail is stacked in a stack unit for rejection (not shown).

By the unread processing described above, unnecessary information such as a barcode, character and symbol are not read even if the mail is exactly sorted without being mechanically processed later.

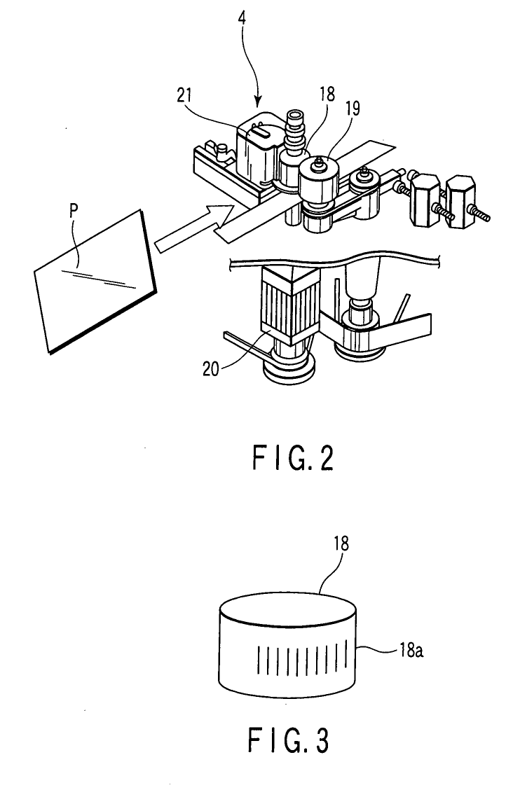

FIG. 2 is a perspective view showing the unread processor 4 described above.

The unread processor 4 has a hub 18. The hub 18 is driven by a driving motor 20. In proximity to the hub 18, an ink roller 21 is provided to supply ink to the hub 18. On the other side, a backup roller 19 is provided opposite to the hub 18 through the conveying path 2. An engraving of barcode 18a is formed on the circumference (the engraved surface) of the hub 18.

Next, an explanation will be given on the processing operation of the unread processor 4.

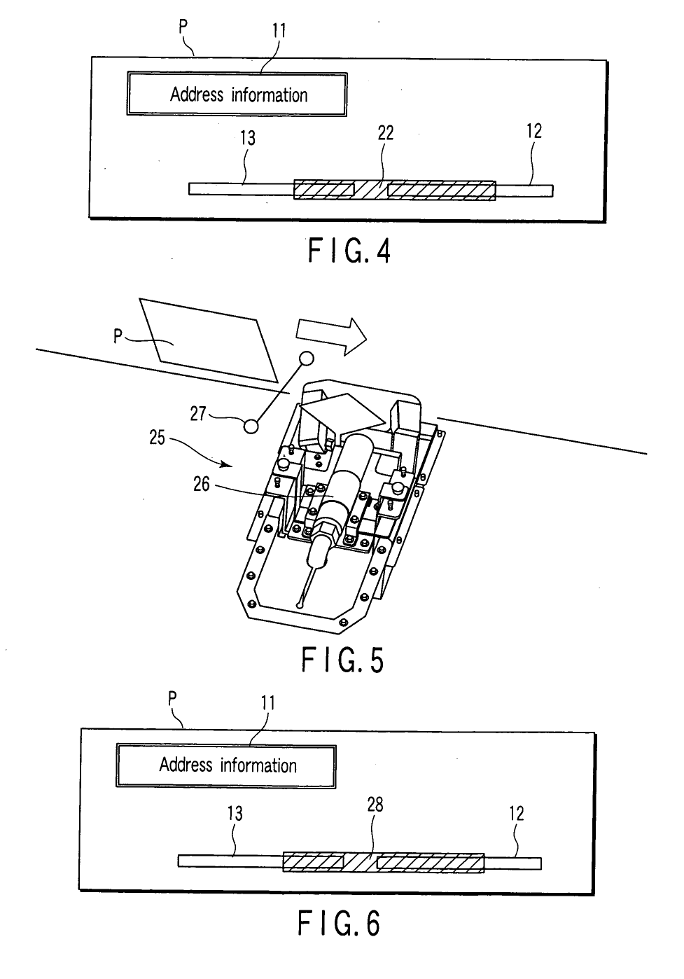

When the mail P read whose information is read by the reader 3 is conveyed toward the unread processor 4 and an unread processing command is issued from the controller 9, the hub 18 is driven by the driving motor 20 to meet the conveyance of the mail P. The hub 18 is revolved, the ink roller 21 supplies ink to the engraving of barcode 18a, and the ink is transferred to the barcodes 12/13 of the conveyed mail P, as a print pattern 22 as shown in FIG. 4, thereby the unread processing is performed.

The engraving of barcode 18a is formed on the circumference of the hub 18. If the engraving of barcode 18a is formed in the same format as the barcodes 12/13 of the mail P, the engraving of barcode 18a may become the same as the barcodes 12/13 of the mail P, and the unread processing may fail.

Therefore, the engraving of barcode 18a of the hub 18 is formed with pitches displaced slightly from the pitches of the barcodes 12/13.

Further, when the information about the mail P is not a barcode but a character or a symbol, a character or symbol is engraved on the circumference of the hub 18, and the space between characters is made different from the print format of the mail P.

FIG. 5 is a perspective view showing the unread processor 25 according a second embodiment of the invention.

The unread processor 25 has an inkjet printer (IJP) 26. The inkjet printer 26 has a primary characteristic to print a barcode, character and a symbol on mail. In the upstream side of the mail conveying direction of the inkjet printer 26, a timing sensor 27 is provided to detect mail.

When the timing sensor 27 detects the mail P in the state that the reader 3 reads the information about mail P and the controller 9 gives the unread processing command to the inkjet printer 26, the inkjet printer 26 ejects ink at a predetermined timing to meet the conveyance of the mail P, and prints the barcode 28 on the barcodes 12/13 printed on the mail P, just like overwriting, as shown in FIG. 6. This makes it impossible to read the barcodes 12/13 printed on the mail P.

The inkjet printer 26 prints the barcode 28 in the format displaced a little from the pitches of the barcodes 12/13 on the mail P, as in the above-mentioned hub of the first embodiment.

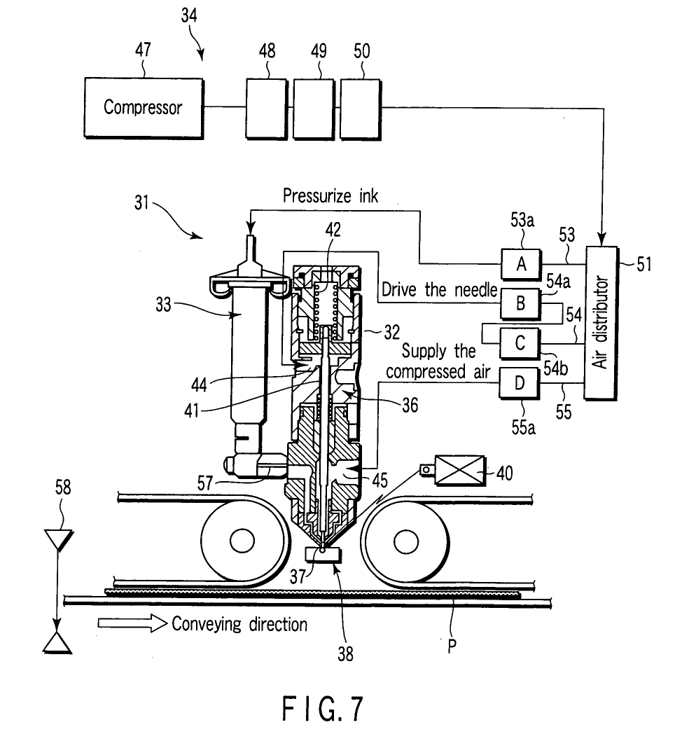

FIG. 7 is a block diagram showing an unread processor 31 according to a third embodiment of the invention.

The unread processor 31 is of the spray valve type, and has a spray valve 32, an ink syringe 33 to contain ink, and a compressed air supply mechanism 34 to supply compressed air to the spray valve 32 and ink syringe 33.

The spray valve 32 has a valve main body 36. A nozzle port 37 is provided in the lower end part of the valve main body 36. The nozzle port 37 is covered by a nozzle cover 38. The nozzle cover 38 is moved by a plunger solenoid 40, between the position to cover the nozzle port 37 and the position to retract from that position. Namely, the nozzle cover 38 covers the nozzle port to prevent the ink from dripping and drying, while the machine is stopping or the spray valve 32 is not spraying ink, and is opened when spraying the ink to the mail.

Inside the valve main body 36, a needle 41 is provided movably in the vertical direction to open and close the nozzle port 37. In the upper part of the valve main body 36, a coil spring 42 is provided. The needle 41 is elastically depressed by the coil spring 42, and closes the nozzle port 37 at the lower end.

A first lead-in chamber 44 to lead in compressed air is provided in the upper part of the valve main body 36, and a second lead-in chamber 45 to lead in compressed air and ink is provided in the lower part. When compressed air is led into the first lead-in chamber 44, the needle 41 is moved up against the energizing force of the coil spring 42, and the nozzle port 37 is opened. When compressed air and ink are led into the second lead-in chamber 45 in the state that the nozzle port 37 is being opened, the ink is sprayed from the nozzle port 37.

The above-mentioned compressed air supply mechanism 34 has a compressor 47. The compressor 47 is connected to an air distributor 51 through a mist separator 48, an air filter 49, and a regulator 50.

The air distributor 51 is connected to the upper part of the ink syringe 33 through a first air supply path 53 for pressuring ink, connected to the first lead-in chamber 44 of the valve main body 36 through a second air supply path 54 for driving the needle, and connected to the second lead-in chamber through a third air supply path 55 for spraying ink. The lower part of the ink syringe 33 is connected to the second lead-in chamber 45 through an ink supply path 57. The first air supply path 53 has a valve 53a, the second air supply path 54 has a valves 54a and 54b, and the third air supply path 55 has a valve 55a.

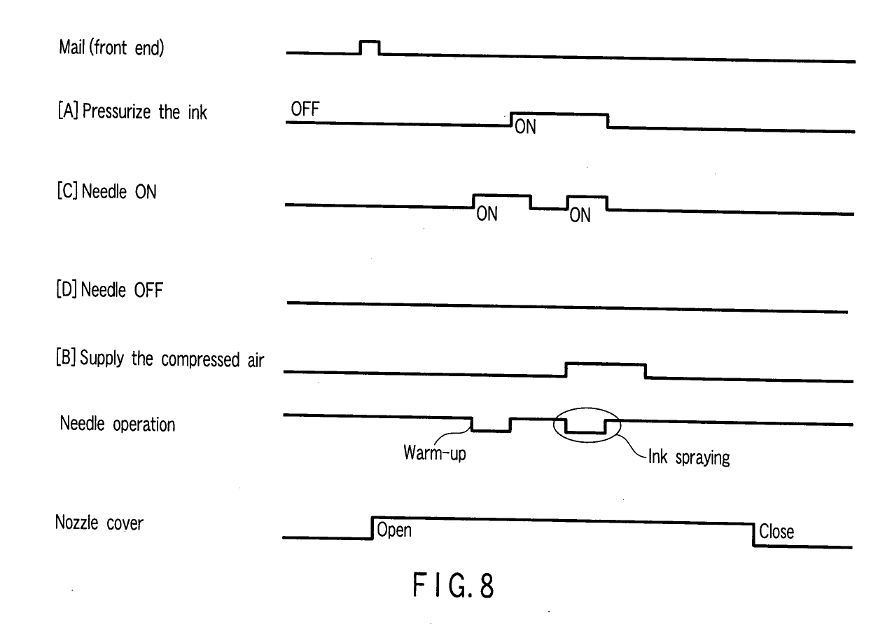

Next, an explanation will be given on the operation of the unread processor 31 configured as described above by referring to the timing chart of FIG. 8.

When the front end of the conveyed mail P passes a timing sensor 58, the sensor signal is detected, the plunger solenoid 40 is excited, and the nozzle cover 38 is opened. Then, the valves 54a and 54b of the second air supply path 54 are opened/closed, and the needle 41 starts warm-up by moving up/down. Namely, when the valves 54a and 54b are opened, the compressed air from the compressor 47 is supplied to the first lead-in chamber 44, and the needle 41 is moved up against the depressing force of the coil spring 42. When the valves 54a and 54b of the second air supply path 54 are closed in this state, the supply of compress air to the first lead-in chamber 44 is stopped, and the needle 41 is moved down by the depressing force of the coil spring 42. By such a warm-up of the needle 41, the responsivity of the needle 41 is not lowered when actually spraying ink, even if the ink in the valve main body 36 is coagulated.

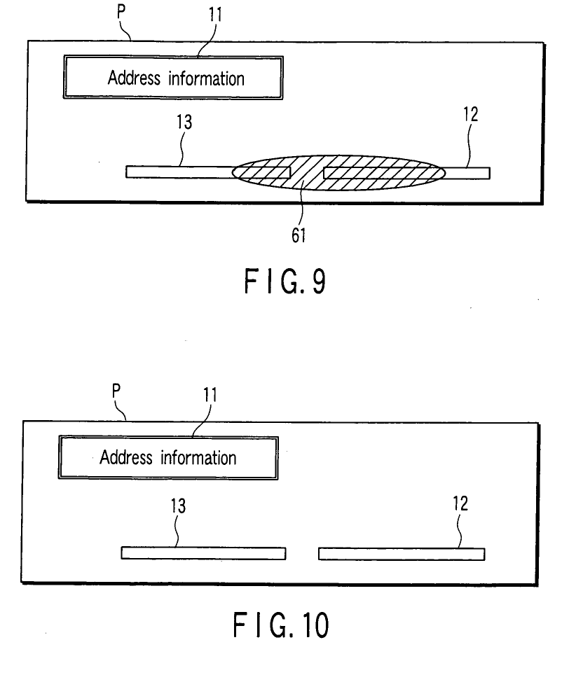

Contrarily, during the warm-up of the needle 41, the valve 53a of the first air supply path 53 is opened, compressed air is supplied to the ink syringe 33, and the ink in the ink syringe 33 is supplied to the second lead-in chamber through the ink supply path 57. During supplying the ink, the valves 54a and 54b of the second air supply path 54 are opened, compressed air is supplied to the first lead-in chamber 44, and the nozzle port 37 is opened. In this time, the valve 55a of the third air supply path 55 is opened, and compressed air is supplied to the second lead-in chamber 45. Therefore, ink is sprayed from the nozzle port 37, and transferred to the barcodes 12/13 of the mail P as shown in FIG. 9, making the barcodes 12/13 unreadable.

Next, description will be given on two concrete examples of warm-up of the needle 41.

For example, at startup of the machine, the needle 41 is warmed up by moving up/down about 10 times.

When mail is conveyed, but a command to spray ink is not issued for a long time during operation, the needle 41 is warmed up by moving up/down once whenever 3000 mails pass.

By the above warm-up of the needle 41, ink can be sprayed at the same timing without lowering the responsivity of the needle 41, even if the ink is coagulated.

The above warm-up is performed only when an unread unit is allowed to use. If an unread unit is not allowed to use, warm-up is not performed and ink is not sprayed.

The number of warm-up times can be changed by a parameter. A parameter is changed according to climates, and operating states and conditions of an unread unit, and is selectable to spray ink at an optimum timing.

In the embodiment described hereinbefore, two kinds of barcodes 12 and 13 printed on the mail P are made unreadable, for example. More than two barcodes may be subjected to the unread processing.

It is also allowed to make one of barcodes unreadable and to leave the others readable. For example, when two barcodes are printed on mail, the unread processor 31 may be controlled to spray ink only for one barcode, and to leave the other barcode readable.

An object of the unread processing is not limited to a barcode. The unread processing may be performed for characters, symbols, or combination of barcode, character and symbol.

Ink used for the unread processing may have substantially the same components as those of ink used for recording a barcode, character and symbol printed on mail P. If ink having different components is used, ink repel each other, and overwriting of unnecessary information may fail. Stable overwriting is realized by using ink having substantially the same components.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A paper processing apparatus comprising:
a conveying device which conveys a paper sheet;
a reading device which reads information about a paper sheet conveyed by the conveying device; and
a processing device which makes unnecessary information unreadable, when the information read by the reading device includes unnecessary information.

2. A paper sheet processing apparatus comprising:
a conveying device which conveys a paper sheet;
a reading device which reads information about a paper sheet conveyed by the conveying device; and
an ink transfer device which makes unnecessary information unreadable by contacting and transferring ink to unnecessary information, when the information read by the reading device includes unnecessary information.

3. The paper sheet processing apparatus according to claim 2, wherein the unnecessary information is a barcode, character and symbol; and the ink transfer device has an engraved surface to form a barcode, character and symbol having substantially the same form as a barcode, character and symbol of the paper sheet, and overwrites the unnecessary information by transferring ink to the barcode, character and symbol of the engraved surface, and bring the engraved surface into contact with the barcode, character and symbol of the paper sheet in a slightly displaced state.

4. A paper sheet processing apparatus comprising:
a conveying device which conveys a paper sheet;
a reading device which reads information about the paper sheet conveyed by the conveying device; and
an ink spray device which makes unnecessary information unreadable by overwriting unnecessary information by spraying ink in substantially the same form and slightly displaced from the unnecessary information, when the information read by the reading device includes unnecessary information.

5. The paper sheet processing apparatus according to claim 4, wherein the unnecessary information is barcode, character and symbol; and the ink spray device sprays ink to the barcode, character and symbol of the paper sheet.

6. A paper sheet processing apparatus comprising:
a conveying device which conveys a paper sheet;
a reading device which reads information about the paper sheet conveyed by the conveying device; and
an ink spray device which makes unnecessary information unreadable by spraying ink to unnecessary information, when the information read by the reading device includes unnecessary information.

7. The paper sheet processing apparatus according to claim 6, wherein the ink spray device has a spray valve to open and close a nozzle port by operation of a needle, an ink supply unit to supply ink to the spray valve, and an air supply unit to supply compressed air to the spray valve.

8. The paper sheet processing apparatus according to claim 6, wherein the ink spray device use ink of the same kind as the ink used for recording unnecessary information about the paper sheet.

9. The paper sheet processing apparatus according to claim 7, wherein the needle is warmed up at startup of operation or when ink is not sprayed during operation.
